(19) United States
(12) Patent Application Publication
(10) Pub. No.: US 2013/0120594 A1
(43) Pub. Date: May 16, 2013

(54) ENHANCEMENT OF DIGITAL IMAGE FILES

(71) Applicant: David A. KRULA, San Diego, CA (US)

(72) Inventor: David A. KRULA, San Diego, CA (US)

(21) Appl. No.: 13/296,646

(22) Filed: Nov. 15, 2011

(51) Int. Cl. H04N 5/225; H04N 5/76

(52) U.S. Cl. 348/207.1; 348/231.3; 348/231.4; 348/E05.048

(57) ABSTRACT

An apparatus to enhance digital image files includes at least a digital image file editing capability and may also include a digital image file capture capability. Upon capture of a digital image file, an editing module allows the digital image file to be enhanced by adding information as desired by the user such as context information and subject matter information. The information to be added may be received by the apparatus through a voice interface or a text interface and then converted (if necessary) for storage as metadata associated with the digital image file. The metadata can be stored in a field or in association with a tag that is part of the digital image file format.

### BACKGROUND

1. Field of the Invention

The present invention generally relates to digital image capture and more particularly relates to enhancing digital image files.

2. Related Art

Conventional digital image capture devices such as cell phones, personal digital assistants (“PDAs”), digital cameras and digital video cameras in both commercial and professional grades function extremely well for their specific function of capturing a single digital image or a series of digital images (i.e., video). However, the conventional systems suffer from an inability to completely capture information related to the subject matter of the digital image or digital video. Therefore, what is needed is a system and method that overcomes these significant problems found in the conventional systems as described above.

### SUMMARY

In order to solve the problems associated with the conventional systems identified above, described herein are an apparatus, system and method to enhance digital image files and digital video files (collectively referred to herein as “digital image files”). An apparatus includes a digital image file capture capability and a digital image file editing capability. Upon capture of a digital image file, the editing module allows the digital image file to be enhanced by adding information as desired by the user such as context information and subject matter information. The information to be added may be received by the apparatus through a voice interface or a text interface and then converted (if necessary) for storage as metadata associated with the digital image file. The metadata can be stored in a field or in association with a tag that is part of the digital image file format.

A system includes an apparatus that is communicatively coupled with a server device via a communication network. The apparatus captures a digital image file and the metadata to be associated with the digital image file and is configured to send the metadata to the server device for conversion into a format that can be included in the digital image file.

A method includes the steps of capturing a digital image file and receiving an input from a user and converting that input if necessary to a format that can be included in the digital image file. The enhanced digital image file that includes the input from the user is then stored.

A further capability of the apparatus, system and method described herein is a social media interface that allows the user provided metadata stored as part of the digital image file to be provided to a social media server as a caption or description to be associated with the digital image file on the social media server.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIG. 1 is a network diagram illustrating an example system for enhancing digital image files according to an embodiment of the invention;

FIG. 2 is a block diagram illustrating an example digital image capture device according to an embodiment of the invention;

FIG. 3 is a block diagram illustrating an example personal computer according to an embodiment of the invention;

FIG. 4 is a flow diagram illustrating an example process for enhancing a digital image file according to an embodiment of the invention;

FIG. 5 is a flow diagram illustrating an example process for uploading a digital image file to a server according to an embodiment of the invention; and

FIG. 6 is a block diagram illustrating an example wired or wireless processor enabled device that may be used in connection with various embodiments described herein.

### DETAILED DESCRIPTION

Certain embodiments disclosed herein provide for a digital image capture apparatus configured to enhance the digital image file with information provided by a user of the digital image capture device. For example, one method disclosed herein allows for a user of the digital image capture device to capture a digital image and then speak certain contextual information that the user desires to be part of the digital image file. The spoken contextual information is then converted to text data and stored as part of the digital image file. After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

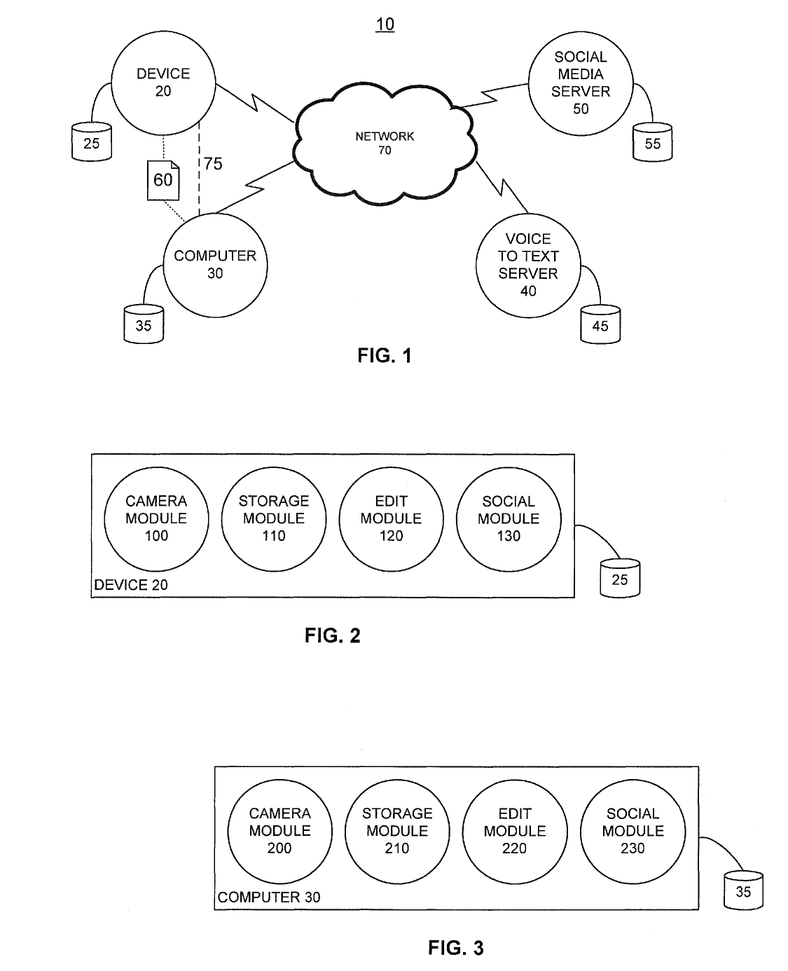

FIG. 1 is a network diagram illustrating an example system 10 for enhancing digital image files according to an embodiment of the invention. In the illustrated embodiment, the system 10 comprises a digital image capture device 20 that is configured with a data storage area 25. The system 10 also includes a personal computer 30 that is configured with a data storage area 35. The system 10 also includes a voice to text server 40 that is configured with a data storage area 45 and a social media server 50 that is similarly configured with a data storage area 55. The digital image capture device 20 and the computer 30 are communicatively coupled with the voice to text server 40 and the social media server 50 via a wired or wireless network 70. The digital image capture device 20 may also be communicatively coupled with the computer 30 via the network 70. Alternatively, the digital image capture device 20 may be communicatively coupled with the computer 30 via a direct wired or wireless connection 75 or via a removable media device 60.

In operation, the digital image capture device 20 captures a digital image file and receives information from a user and modifies the stored digital image file to include the information from the user. The captured digital image file and the information from the user can be temporarily or persistently stored in internal memory 25. The information may be received from the user in a text or voice format and if received in a voice format the device 20 may convert the voice format data to text format and store the enhanced digital image file that includes the converted voice data as part of the digital image file. Alternatively, the device 20 may send the voice format data to the voice to text server 40 for conversion to text and then receive the converted voice data as text format data and store the enhanced digital image file that includes the converted voice data as part of the digital image file.

Additionally, the digital image capture device 20 may capture one or more digital image files and store the files on a removable storage medium 60 and then read the digital image files from the removable storage medium 60 using the computer 30. In such an embodiment, the computer 30 may then receive information from the user in a text or voice format and if received in a voice format the computer 30 may convert the voice format data to text format and store the enhanced digital image file that includes the converted voice data as part of the digital image file. Alternatively, the computer 30 may send the voice format data to the voice to text server 40 for conversion to text and then receive the converted voice data as text format data and store the enhanced digital image file that includes the converted voice data as part of the digital image file.

FIG. 2 is a block diagram illustrating an example digital image capture device 20 according to an embodiment of the invention. In the illustrated embodiment, the device 20 comprises a camera module 100, a storage module 110 an edit module 120 and a social module 130. The device 20 also is configured with a data storage area 25 as previously described.

The camera module 100 is configured to capture digital image files including still images and video images. Video images can be captured with or without corresponding audio data. As will be understood by those skilled in the art, the camera module 100 may operate and control a camera device that is integral to the digital imaging device 20 in order to capture the digital image files.

The storage module 110 is configured to work cooperatively with the camera module 100 to store the digital image files that are captured by the camera module 100. The digital image files can be stored in the internal data storage area 25, which may comprise volatile and non-volatile memory means. The digital image files can be stored in the removable media device 60, which may also comprise volatile and non-volatile memory means.

The edit module 120 is configured to interact with a user to receive instructions and data for enhancing a digital image file. The edit module 120 is configured to interact with the user using an audio interface (e.g., receiving voice data from the user). The edit module 120 is also configured to interact with the user using a text interface (e.g., receiving text data from the user). In operation, the edit module 120 is triggered upon storage of a digital image file by the storage module 110. Upon detecting the storage of a digital image file by the storage module 110, the edit module 120 may prompt the user for any additional information that the user wishes to associate with the digital image file. The edit module 120 may prompt the user using an audio prompt or a visual prompt or both. For example, upon detecting the storage of an image file by the storage module 110, the edit module 120 may cause the speaker on the device 20 to play the audio prompt “ADDITIONAL INFORMATION” to the user. Alternatively, or in combination, the edit module may cause the display on the device 20 to present the visual prompt “ADDITIONAL INFORMATION” to the user. As will be understood by those skilled in the art, the prompt may include a variety of different content.

If the user desires to associate additional information with the digital image file, the edit module 120 receives a positive response from the user and proceeds to interact with the user and receive the additional information. The edit module 120 may repeatedly prompt the user for specific information (e.g., title, location, caption and subject, just to name a few) or the edit module 120 may allow the user to provide free form input or the edit module 120 may employ some combination of these and other data input techniques. In one embodiment, the user may type or speak certain keywords followed by the specific information. For example, the user may speak “CAPTION” followed by “HIKING ELISABETH PASS” and the edit module 120 receives that voice input and converts it to text and then stores “HIKING ELISABETH PASS” in association with the digital image file as its caption. In one embodiment, the edit module 120 may convert voice input to text in cooperation with a voice to text module (not shown) such as Vlingo or Siri. Alternatively, the edit module may send the voice data to a voice to text server for conversion to text.

Once the edit module 120 has received the additional information, it stores the information in association with the digital image file to create an enhanced digital image file. In an alternative embodiment, the edit module 120 may work in cooperation with the storage module 110 to store the enhanced digital image file. Advantageously, the edit module 120 is configured to employ unused fields in the digital image file to store the additional information. For example, in a JPEG file format the edit module 120 may store the additional information in the APPN field or in the COMMENTS field. Alternatively, in a TIFF file format the edit module 120 may store the additional information in the PRIVATE TAGS field. The additional information may be stored in a keyword:data format, for example, “CAPTION: HIKING ELISABETH PASS” to continue with the example from above. Advantageously, multiple instances of keyword:data combinations can be stored in the digital image file to enhance the digital image file with a rich set of additional information.

The social module 130 is configured to upload digital image files to a social media server. Advantageously, the social module 130 is configured to provide the social media server with the additional information provided by the user so that the social media server can associate that information with the digital image file on the social media website. For example, when uploading a digital image file to a social media server, the social module 130 submits the text “HIKING ELISABETH PASS” to the social media server as a caption for the digital image file. In one embodiment, the social module 130 may also identify the individuals that appear in the digital image file and cause the social media server to interactively receive an indication from the user (e.g., designation of a region in the digital image) to associate with the name of an individual. In this fashion, the social media module 130 is configured to facilitate automatic captioning of an uploaded digital image file and is also configured to facilitate interactive tagging of the individuals that appear in a digital image. Additional attributes or other information about the digital image file or its content can also be provided by the social media module 130 to a social media server.

FIG. 3 is a block diagram illustrating an example personal computer device 30 according to an embodiment of the invention. To the extent that the modules on the personal computer device 30 are the same as the modules previously described on the device 20, that description will not be repeated with respect to FIG. 3. Importantly, the computer 30 may receive digital image files or enhanced digital image files from the device 20, for example, via a direct wired or wireless connection (e.g., a cable), via an indirect wired or wireless connection (e.g., a network or Bluetooth® link), or via a shared memory or a portable media.

The camera module 200 is configured to capture digital image files including still images and video images. Video images can be captured with or without corresponding audio data. As will be understood by those skilled in the art, the camera module 200 may operate and control a camera device that is integral to the computer device 30 in order to capture the digital image files.

The storage module 210 may store digital image files originally captured by the device 30 or it may also store digital image files received from another device via a wired or wireless connection or via a shared memory or a portable media.

The edit module 220 may edit digital image files originally captured by the device 30 or it may also edit digital image files received from another device via a wired or wireless connection or via a shared memory or a portable media.

The social module 230 may upload digital image files to a social media server and those digital image files may be originally captured by the device 30 or it may also edit digital image files received from another device via a wired or wireless connection or via a shared memory or a portable media.

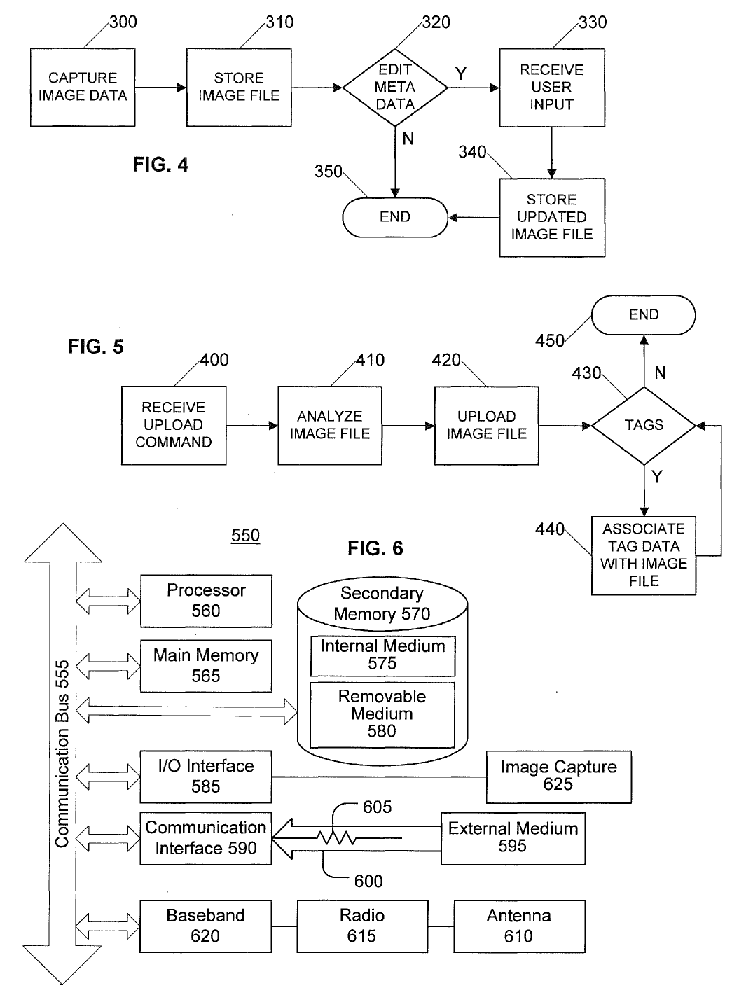

FIG. 4 is a flow diagram illustrating an example process for enhancing a digital image file according to an embodiment of the invention. The illustrated process may be carried out by a digital image capture device or a computer device such as previously described with respect to FIGS. 1-3. Initially, in step 300 the device captures the image data and the image data is stored as a digital image file in step 310. The digital image file may be stored in a variety of formats including for example, JPEG and TIFF. Next, in step 320 the device determines if the user desires to enhance the digital image file. This may be determined by an audio or visual prompt to the user of the device in combination with analysis of input from the user in response to the prompt. If the user does not desire to enhance the digital image file, the process ends in step 350.

If the user does desire to enhance the digital image file, in step 330 the device receives the user input. The user input may be received as audio or text data and may be received in response to specific prompts from the device or in a free form fashion. For example, the device may prompt the user for a caption and then associate the next input received from the user with the caption. The device may then prompt the user for the name of a person appearing in the digital image and then store the next input received from the user as the name of the person in the digital image. In one embodiment, the device may use a series of tags and data to associate the information provided by the user with the digital image file. In such an embodiment, the CAPTION tag can be associated with the caption information provided by the user and the SUBJECT tag can be associated with the person appearing in the digital image information provided by the user. Alternative and additional tags may also be used to associate a rich set of additional information about the digital image file with the digital image file.

Once all of the user input has been received and associated with the digital image file, the device stores the updated digital image file as an enhanced digital image file as shown in step 340. After the enhanced digital image file has been stored, the process ends in step 350.

FIG. 5 is a flow diagram illustrating an example process for uploading a digital image file to a server according to an embodiment of the invention. The illustrated process may be carried out by a digital image capture device or a computer device such as previously described with respect to FIGS. 1-3. Initially, in step 400 the device receives an upload command or upload instruction from the user. The upload instruction identifies the digital image file or files to be uploaded to the server. For simplicity, the process will be described in the context of uploading a single digital image file, however, a plurality of digital image files can also be uploaded as will be understood by those skilled in the art. In one embodiment, the server can be a social media server.

Next, in step 410 the device analyzes the digital image file to determine if the digital image file is an enhanced digital image file. The device then begins to upload the digital image file in step 420. If the file is an enhanced digital image file, then in step 430 the device determines if there are certain tags associated with the enhanced digital image file. If there are, then in step 440 the device instructs the server to associate the tag data with the digital image file. For example, if the digital image file includes a CAPTION tag, then the device is configured to notify the server that the data associated with the CAPTION tag in the digital image file is to be used as a caption for the digital image file on the server. Advantageously, the process repeats through all of the tags that are associated with the enhanced digital image file as can be seen by repeated looping through the determining step 420 and the associating step 440. When all of the tags have been processed (note that in some cases not all tags will be used to associate information with the digital image file on the server), then the process ends in step 450.

Example uses for the enhancement of digital image files includes enhancing digital image files when the user is out and about, for example during a hike or an extended vacation. Alternatively, the enhancement of digital image files could also be used by a professional photographer at a wedding or other event. Advantageously, the voice data may be supplied by the subject of the digital image rather than the user of the digital image capture device. In one embodiment, the enhancement of digital image files can be used by an investigator to capture forensic or other information about the context of the digital image. As will be understood by those skilled in the art, the application of enhanced digital image files can apply across a wide variety of industries and leisure activities.

FIG. 6 is a block diagram illustrating an example wired or wireless system 550 that may be used in connection with various embodiments described herein. For example the system 550 may be used as or in conjunction with a digital image capture device, a computing device, or a server device as previously described with respect to FIGS. 1-3. The system 550 can be a digital camera, digital video recorder, personal digital assistant, cellular phone, smart phone, tablet computer, personal computer, computer server, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, I²C, parallel, serial, USB, Firewire, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include a internal memory 575 and/or a removable medium 580, for example a floppy disk drive, a magnetic tape drive, a compact disc (“CD”) drive, a digital versatile disc (“DVD”) drive, SD card, T-Flash, Thumb drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 590. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

In one embodiment, the system 550 includes an image capture module 625 that is configured to capture image data. The image capture module 625 may be communicatively coupled with the processor 560 and the main memory 565 via the I/O interface 585 as shown or it may be connected directly to the communication bus 555. In one embodiment, the image capture module 625 is an integrated camera.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennas and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that were previously described with respect to FIGS. 2 and 3.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. An apparatus for enhancing digital images comprising:
a non-transitory computer readable medium configured to store executable programmed modules;
a processor communicatively coupled with the non-transitory computer readable medium configured to execute programmed modules stored therein;
a camera module stored in the non-transitory computer readable medium and configured to be executed by the processor, the camera module configured to capture a digital image;
a storage module stored in the non-transitory computer readable medium and configured to be executed by the processor, the storage module configured to store the captured digital image in the non-transitory computer readable medium; and
an edit module stored in the non-transitory computer readable medium and configured to be executed by the processor, the edit module configured to receive information from a user, associate the information with said captured digital image and store the said captured digital image and the associated information as an enhanced digital image in the non-transitory computer readable medium.

2. The apparatus of claim 1, wherein the edit module is further configured to receive said information from a user as audio format information.

3. The apparatus of claim 2, wherein the edit module is further configured to convert said audio format information to text format information.

4. The apparatus of claim 3, wherein said enhanced digital image is stored in a file format in accordance with a joint photographic experts group (“JPEG”) format.

5. The apparatus of claim 4, wherein said text format information is stored in a field of the JPEG format enhanced digital image file.

6. The apparatus of claim 3, wherein said enhanced digital image is stored in a file format in accordance with a tagged image file format (“TIFF”).

7. The apparatus of claim 6, wherein said text format information is stored in a field of the TIFF format enhanced digital image file.

8. The apparatus of claim 1, further comprising a social module stored in the non-transitory computer readable medium and configured to be executed by the processor, the social module configured to upload the enhanced digital image from the non-transitory computer readable medium to a computer server via a network.

9. The apparatus of claim 8, wherein the social module is further configured to analyze the enhanced digital image to determine an image caption and provide said image caption to the computer server in association with the enhanced digital image.

10. A computer implemented method for enhancing digital images, where one or more processors are programmed to perform steps comprising:
identifying a digital image stored in a data storage area;
receiving a user input comprising information associated with said digital image;
editing the digital image to create an enhanced digital image comprising the digital image and the associated information; and
storing the enhanced digital image in the non-transitory computer readable medium.

11. The method of claim 10, further comprising receiving said input from a user as audio format information.

12. The method of claim 11, further comprising converting said audio format information to text format information.

13. The method of claim 12, further comprising storing said enhanced digital image in a file format in accordance with a joint photographic experts group (“JPEG”) format.

14. The method of claim 13, further comprising storing said text format information in a field of the JPEG format enhanced digital image file.

15. The method of claim 12, further comprising storing said enhanced digital image in a file format in accordance with a tagged image file format (“TIFF”).

16. The method of claim 15, further comprising storing said text format information in a field of the TIFF format enhanced digital image file.

17. The method of claim 10, further comprising uploading the enhanced digital image from the non-transitory computer readable medium to a computer server via a network.

18. The method of claim 17, further comprising analyzing the enhanced digital image to determine an image caption and providing said image caption to the computer server in association with the enhanced digital image.
